(19) United States
(12) Patent Application Publication
(10) Pub. No.: US 2015/0301287 A1
(43) Pub. Date: Oct. 22, 2015

(54) MULTIFUNCTIONAL OPTICAL FIBER FIXING CLAMP

(71) Applicant: Yangri Zhao, Shandong (CN)

(72) Inventor: Yangri Zhao, Shandong (CN)

(73) Assignees: INNO INSTRUMENT, INC., Incheon (KR); DH INFOTECH (WEIHAI) INC., WeiHai City, Shandong Province (CN)

(21) Appl. No.: 14/416,030

(22) PCT Filed: Jul. 20, 2012
(86) PCT No.: PCT/CN2012/078923

§ 371 Date: Jun. 24, 2015

(51) Int. Cl. G02B 6/36; G02B 6/38

(52) U.S. Cl. CPC G02B 6/3616; G02B 6/3636; G02B 6/3898

(57) ABSTRACT

The invention relates to the technical field of optical fiber cutting and welding, especially a multi-functional optical fiber fixing clamp. The multi-functional optical fiber fixing clamp of the invention comprises a clamp body and a clamp cover. One side of the said clamp body is pin jointed to the said clamp cover. The said clamp body is arranged with a first fiber loading slot and a fiber connector locating slot. The said clamp cover is arranged with a first abutting structure which is abutted with the said first fiber loading slot and a second abutting structure which is abutted with the said fiber connector locating slot. Compared with the existing technology, the multi-functional optical fiber fixing clamp of the invention can match with SC optical fiber connector, LC optical fiber connector, rubber-insulated fiber cable and wire jumper. As the clamp has the compatibility function, operators are not required to change clamp during a series of operations such as optical fiber cutting and welding. Thus, working time is greatly saved and work efficiency is improved.

### TECHNICAL FIELD

The invention relates to the field of optical fiber cutting and welding, especially relates to a multi-functional optical fiber fixing clamp for fixing optical fiber or optical fiber connector during optical fiber cutting and welding process.

### BACKGROUND ART

With the continuous improvement of communication technology, users have higher and higher requirements on information transmission speed and quality, optical communication as well as its strengths emerge gradually, and fiber-to-the-home (FTTH) becomes the irresistible trend of development. After home-entry optical cable is laid, generally, fiber connector will be used to connect the optical cable (rubber-insulated fiber cable or wire jumper) with the terminal. Connection of fiber connector with optical cable means the connection of embedded optical fiber in the fiber connector with the optical fiber in the optical cable. There are two kinds of connection, namely cold connection and hot connection. Compared with cold connection, hot connection (namely hot melt connection) is widely used, due to low fusion loss, high stability and long life, no change along with the change of temperature, and low later-period maintenance cost. As to hot melt connection, first of all, end face of the optical fiber (including the embedded optical fiber in the connector and the optical fiber to be connected in the cable) shall be cut by the optical fiber cutter. After being cut to be flat, the fiber is placed on the fusion splicer for fusion welding. To meet the required cutting and welding effect, fiber connector and optical cable (rubber-insulated fiber cable or wire jumper) shall be fixed with a special clamp during cutting and fusion welding process.

Currently, since most of the existing clamps can only apply to fiber connectors of single model, or rubber-insulated fiber cable or wire jumper, during optical fiber cutting and hot melt connection operation, operators are required to select a clamp matching with fiber connector to fix the fiber connector, then select a clamp matching with rubber-insulated fiber cable to fix rubber-insulated fiber cable, or select a clamp matching with wire jumper to fix the wire jumper. During operation, clamps are required to be changed frequently, which is extremely inconvenient, leading to low work efficiency.

### SUMMARY

The present invention is intended to solve the technical problem that, generally, clamps of the existing technology can only apply to fiber connectors of single model, or rubber-insulated fiber cable or wire jumper, which results in during optical fiber cutting and hot melt connection operation, operators are required to select a clamp matching with fiber connector to fix fiber connector, then select a clamp matching with rubber-insulated fiber cable to fix rubber-insulated fiber cable, or select a clamp matching with wire jumper to fix wire jumper, therefore, during the operation, clamps are required to be changed frequently, which is extremely inconvenient, leading to low work efficiency, so as to provide a multi-functional optical fiber fixing clamp.

Purpose of the present invention is realized via the following technical proposal:

A multi-functional optical fiber fixing clamp, comprising a clamp body and a clamp cover, wherein one side of the said clamp body is pin jointed to the said clamp cover; the said clamp body is arranged with a first fiber loading slot and a fiber connector locating slot, correspondingly, the said clamp cover is arranged with a first abutting structure which is abutted with the said first fiber loading slot and a second abutting structure which is abutted with the said fiber connector locating slot.

Preferentially, the said first fiber loading slot is connected to the said fiber connector locating slot, and bottom of the said first fiber loading slot is higher than that of the said fiber connector locating slot.

Preferentially, the said clamp body is further arranged with a second fiber loading slot, correspondingly the said clamp cover is arranged with a third abutting structure which is abutted with the said second fiber loading slot; the said first fiber loading slot is connected to the said second fiber loading slot, and bottom of the said second fiber loading slot is higher than that of the said first fiber loading slot.

Preferentially, appearance of the said fiber connector locating slot matches with that of a fiber connector.

Preferentially, the said clamp cover is arranged with an accommodating unit which matches with the appearance of the fiber connector.

Preferentially, the said accommodating unit comprises an accommodating hole or an accommodating slot.

Preferentially, the said second abutting structure comprises a first elastomer arranged in the said accommodating unit, and the said first elastomer protrudes from the said accommodating unit.

Preferentially, the said first elastomer comprises a sponge.

Preferentially, the said first abutting structure comprises a second elastomer, and the said third abutting structure comprises a third elastomer.

Preferentially, material of the said second elastomer and the said third elastomer is rubber.

Preferentially, the said second fiber loading slot is of “V” shape.

Preferentially, the said clamp body is further arranged with a first position-limited block and a second position-limited block, and the said first position-limited block and the said position-second limited block are symmetrically arranged on the edges of the said first fiber loading slot.

Preferentially, the said clamp body is further arranged with several locating holes for connecting with the fusion splicer and a through-hole for matching with a guide block of the fusion splicer.

Preferentially, material of the said clamp cover is metal; the said clamp body is arranged with a magnetic body, and the other side of the said clamp body is connected to the said clamp cover via the said magnetic body.

Preferentially, the other side of the said clamp body is buckled with the said clamp cover, wherein the said clamp cover is arranged with a slot, and the said clamp body is arranged with a snap body which can be buckled to the said slot.

Preferentially, an edge of the said first fiber loading slot is arranged with a scale.

Compared with the existing technology, the multi-functional optical fiber fixing clamp of the invention can match with SC optical fiber connector, LC optical fiber connector, rubber-insulated fiber cable and wire jumper. As the clamp has the function of compatibility, operators are not required to change clamp during a series of operations including optical fiber cutting and welding. Thus, working time is greatly saved and work efficiency is improved.

### BRIEF DESCRIPTION OF THE FIGURES

FIG. 1 shows a structure diagram of the multi-functional optical fiber fixing clamp of the present invention;

FIG. 2 shows a structure diagram of the clamp body of the multi-functional optical fiber fixing clamp of the present invention;

FIG. 3 shows a diagrammatic drawing of the multi-functional optical fiber fixing clamp of the present invention when fixing a fiber connector;

FIG. 4 shows a diagrammatic drawing of the multi-functional optical fiber fixing clamp of the present invention when fixing a rubber-insulated fiber cable;

FIG. 5 shows a diagrammatic drawing of the multi-functional optical fiber fixing clamp of the present invention when fixing a wire jumper;

FIG. 6 shows a structure diagram of the multi-functional optical fiber fixing clamp of the present invention when closed.

### DETAILED DESCRIPTION

Now, specific instructions will be given to the present invention by combining the figures.

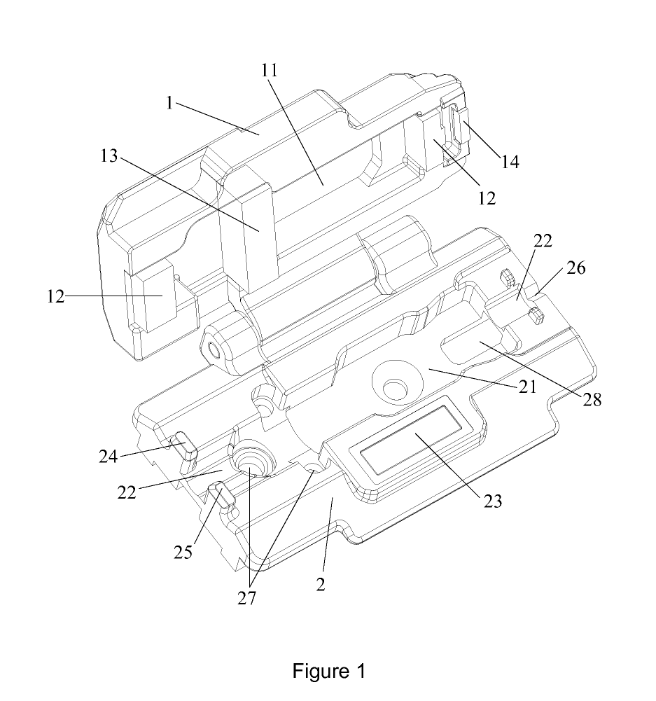

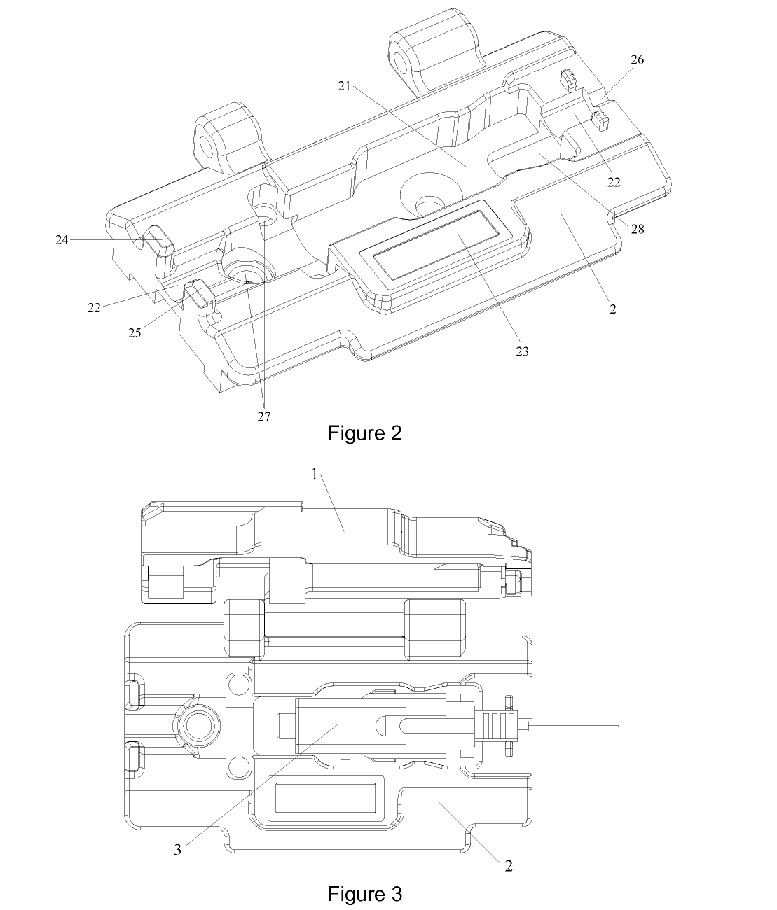

Please refer to FIG. 1 and FIG. 2, a multi-functional optical fiber fixing clamp of the present invention, comprising a clamp body 2 and a clamp cover 1, wherein one side of the clamp body 2 is pin jointed to the clamp cover 1 via a spindle; the clamp body 2 is arranged with a first fiber loading slot 22 and a fiber connector locating slot 21, correspondingly, the clamp cover 1 is arranged with a first abutting structure which is abutted with the first fiber loading slot 22 and a second abutting structure which is abutted with the fiber connector locating slot 21.

In this embodiment, the first fiber loading slot 22 is connected with the fiber connector locating slot 21, wherein the fiber connector locating slot 21 divides the first fiber loading slot 22 into two sections, and bottom of the first fiber loading slot 22 is higher than that of the fiber connector locating slot 21. When the fiber connector is placed in the fiber connector locating slot 21, a front end of the fiber connector is just clamped on the first fiber loading slot 22. In this embodiment, bottom of the first fiber loading slot 22 takes on the shape of an arc slightly, this can coincide with the circular shape of a rubber-insulated fiber cable or a wire jumper.

The clamp body 2 is further arranged with a second fiber loading slot 26, and correspondingly the clamp body 1 is arranged with a third abutting structure which is abutted with the second fiber loading slot 26, wherein the first fiber loading slot 22 is connected with the second fiber loading slot 26, and bottom of the second fiber loading slot 26 is higher than that of the first fiber loading slot 22. In this embodiment, the second fiber loading slot is of “ [symbol] ” shape; when fixing a fiber connector, a rubber-insulated fiber cable or a wire jumper, 900 um optical fiber part in the fiber connector, rubber-insulated fiber cable or wire jumper is just clamped in the “ [symbol] ” shaped fiber loading slot.

In this embodiment, edges of the first fiber loading slot 22 are symmetrically arranged with scales, wherein the scales are close to the second fiber loading slot 26, and are indicated as 12 mm. The scales can be used to control the remaining cutting length of the optical fiber of a rubber-insulated fiber cable or a wire jumper, namely distance from the optical fiber cutting point (namely welding point) to the jacket stripping point of the rubber-insulated fiber cable or wire jumper can be viewed via the scale. In use, the jacket stripping point of the rubber-insulated fiber cable or wire jumper can be a little far away from the fiber cutting point (namely the welding point); specific size can be controlled via the scale, so that the remaining cutting length of the optical fiber can fit for welding by the welding machine.

In this embodiment, appearance of the said fiber connector locating slot 21 matches with that of the fiber connector. In this embodiment, fiber connector can be a SC hot melt connector or a LC hot melt connector. The clamp cover 1 is arranged with an accommodating unit which can match with the appearance of SC hot melt connector or LC hot melt connector, wherein the accommodating unit can be an accommodating hole or an accommodating slot. In this embodiment, the accommodating unit can be an accommodating hole. Since the fiber connector is placed in the fiber connector locating slot 21, when the clamp body 2 and clamp cover 1 are closed, the accommodating hole enables the clamp cover not to clamp the connector body, so that the clamp body and clamp cover can be fully closed.

The second abutting structure comprises a first elastomer 13 arranged in the accommodating unit, and the first elastomer 13 protrudes from the accommodating unit. In this embodiment, the first elastomer is a sponge. When the clamp body 2 and clamp cover 1 are closed, the sponge can abut with the rear part of the fiber connector in the fiber connector locating slot 21, thus the fiber connector is fixed.

The first abutting structure comprises a second elastomers 12, and the third abutting structure comprises a third elastomer 14. In this embodiment, there are two second elastomers 12 which respectively abutting with the two sections of the first fiber loading slot 22. In this embodiment, material of both the second elastomers 12 and the third elastomer 14 is rubber. When the clamp clamps the cable, rubber can play the role of preventing the cable from sliding. When the clamp body 2 and clamp cover 1 are closed, the second elastomers 12 abuts with the rubber-insulated fiber cable or wire jumper placed in the first fiber loading slot 22 or the end of the fiber connector, and the third elastomer 14 abutts with the rubber-insulated fiber cable or wire jumper placed in the second fiber loading slot 26 or the 900 um optical fiber part in the fiber connector, thus the optical fiber is fixed, for the convenience of cutting or welding operation.

In this embodiment, the clamp body 2 is further arranged with a first position-limited block 24 and a second position-limited block 25, which are symmetrically arranged on the edges of the first fiber loading slot 22. When the rubber-insulated fiber cable or wire jumper are to be clamped, the first position-limited block 24 and the second position-limited block 25 can play the role of limiting on the rear end of the rubber-insulated fiber cable or wire jumper. In this embodiment, a third position-limited block and a fourth position-limited block can also be arranged on the clamp body 2, which are symmetrically arranged on the edges of the first fiber loading slot 22 and close to the second fiber loading slot 26, for preliminary positioning of the cable, avoiding deflection.

In this embodiment, the said clamp body 2 is further arranged with several locating holes 27 for connecting with the fusion splicer and a through-hole 28 for matching with a guide block of the fusion splicer. The clamp can be fixed on the fusion splicer via the locating holes 27, while the fusion splicer is arranged with the guiding block for the convenient installation of the clamp, and the through-hole 28 is arranged for matching with the guide block.

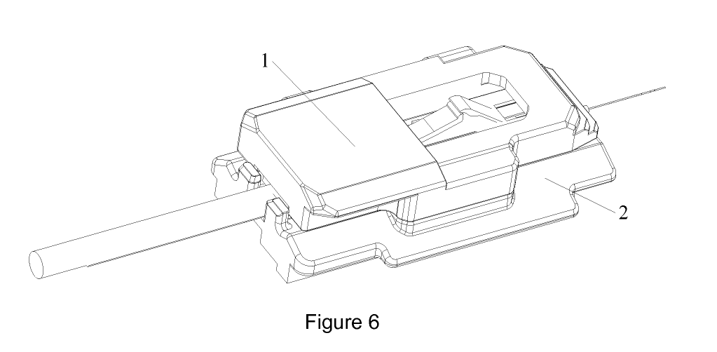

In this embodiment, material of the clamp cover 1 is metal, and the clamp body 2 is arranged with a magnetic body 23, wherein the other side of the clamp body 2 is connected to the clamp cover 1 via the magnetic body 23. The magnetic body 23 is a magnet, with scope of magnetism of 3000 GS-4500 GS, where 4000 GS is preferred. When the clamp is closed, the clamp cover 1 will be attracted by the magnet on the clamp body 2, thus the cover is closed to fix the fiber, as is shown in FIG. 6. In addition, the other side of the clamp body can also be buckled to the clamp cover. By setting a slot on the clamp cover, and setting a snap body on the clamp body, which can be buckled with the slot, when the snap body is buckled into the slot, the other side of the clamp body can be connected to the clamp cover.

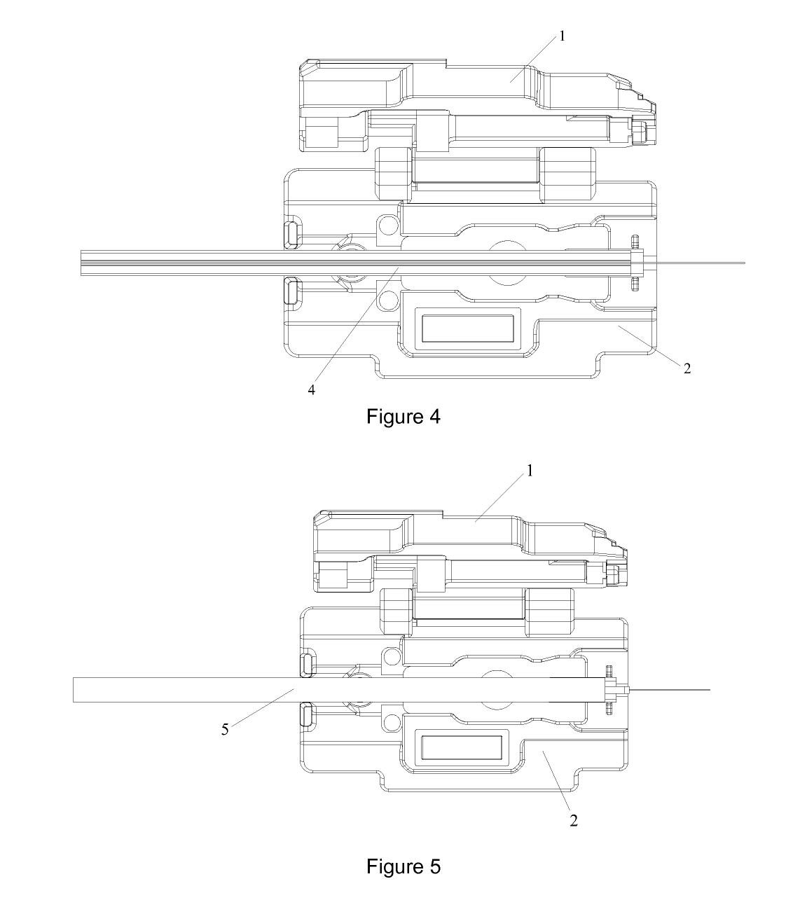

When the optical fiber fixing clamp is in use, the rubber-insulated fiber cable 4 or wire jumper 5 is placed on the first fiber loading slot 22, and the exposed 900 um optical fiber part after the jacket is peeled is just clamped on the second fiber loading slot 26, as is shown in FIG. 4 and FIG. 5. When the clamp body 2 and the clamp cover 1 are closed, the second elastomers 12 is abutted with the rubber-insulated fiber cable or wire jumper, to withhold the rubber-insulated fiber cable or wire jumper. The third elastomer 14 is abutted with the exposed 900 um optical fiber part of the rubber-insulated fiber cable or wire jumper, to withhold the 900 um optical fiber part that on the second fiber loading slot 26. Thus, during cutting or welding, the entire optical fiber can keep the horizontal fixing state, for the convenience of being cut or welded, and makes the cutting or welding effect better. Or, place the fiber connector 3 on the fiber connector locating slot 21, a front end of the fiber connector is just clamped on the first fiber loading slot 22, and the 900 um fiber part in the fiber connector is just clamped on the second fiber loading slot 26, as is shown in FIG. 3. When the clamp body 2 and the clamp cover 1 are closed, the first elastomer is abutted with the rear part of the fiber connector, and the second elastomers is abutted with the end of the fiber connector, therefore the fiber connector can be withheld. The third elastomer 14 is abutted with the 900 um fiber part in the fiber connector, so that the 900 um fiber part on the second fiber loading slot 26 can be withheld, thus, during cutting or welding rprocess, the fiber can keep horizontal fixing state, for the convenience of being cut or welded, and makes the cutting or welding effect better.

During welding process, the multi-functional optical fiber fixing clamp of the present invention shall be symmetrically arranged in the fusion splicer, and shall keep down the two fibers simultaneously for the convenience of welding.

The multi-functional optical fiber fixing clamp of the present invention can match with SC optical fiber connector, LC optical fiber connector, rubber-insulated fiber cable and wire jumper, moreover, it can not only be installed on a fiber cutter but also can be installed in a fashion splicer. Due to the compatibility function of the clamp, operators are not required to change clamp during a series of operations including optical fiber cutting and welding. Thus, working time is greatly saved and work efficiency is improved.

What disclosed above are only a few embodiments of the present application. However, the application is not limited thereto. Any change that can be thought about by technicians in this field shall fall within the scope of protection of the application.

1. A multi-functional optical fiber fixing clamp, comprising:
a clamp body;
a clamp cover, wherein one side of the said clamp body is pin-jointed to the clamp cover;
a first fiber loading slot arranged within the clamp body;
a fiber connector locating slot arranged within the clamp body;
a first abutting structure which abuts the fiber loading slot; and
a second abutting structure which abuts the fiber connector locating slot.

2. The multi-functional optical fiber fixing clamp of claim 1, wherein the first fiber loading slot is connected with the fiber connector locating slot, and a bottom of the first fiber loading slot is higher than that of the fiber connector locating slot.

3. The multi-functional optical fiber fixing clamp of claim 1, wherein the clamp body also includes a second fiber loading slot, wherein the clamp cover is provided with a third abutting structure which abuts the second fiber loading slot, and wherein the first fiber loading slot is connected with the second fiber loading slot, and a bottom of the second fiber loading slot is higher than that of the first fiber loading slot.

4. The multi-functional optical fiber fixing clamp of claim 1, wherein shape of the fiber connector locating slot matches that of a fiber connector.

5. The multi-functional optical fiber fixing clamp of claim 4, wherein the clamp cover includes an accommodating unit, which matches the shape of the fiber connector.

6. The multi-functional optical fiber fixing clamp of claim 5, wherein the accommodating unit comprises an accommodating hole or an accommodating slot.

7. The multi-functional optical fiber fixing clamp of claim 5, wherein the said second abutting structure comprises a first elastomer arranged in the accommodating unit, and the first elastomer protrudes from the accommodating unit.

8. The multi-functional optical fiber fixing clamp of claim 7, wherein the first elastomer comprises a sponge.

9. The multi-functional optical fiber fixing clamp of claim 3, wherein the said first abutting structure comprises a second elastomer, and the third abutting structure comprises a third elastomer.

10. The multi-functional optical fiber fixing clamp of claim 9, wherein material of the second elastomer and the third elastomer is rubber.

11. The multi-functional optical fiber fixing clamp of claim 3, wherein the second fiber loading slot is of “ [symbol] ” shape.

12. The multi-functional optical fiber fixing clamp of claim 1, wherein the clamp body is further provided with a first position-limited block and a second position-limited block, wherein the first position-limited block and the second position-limited block are symmetrically arranged at the bordering of the first fiber loading slot.

13. The multi-functional optical fiber fixing clamp of claim 1, wherein the clamp body is further provided with several locating holes for connecting with the fusion splicer and a through-hole for matching with a guide block of the fusion splicer.

14. The multi-functional optical fiber fixing clamp of claim 1, wherein material of the clamp body is metal; the clamp body is provided with a magnetic body, and the other side of the clamp body is connected to the clamp cover via the magnetic body.

15. The multi-functional optical fiber fixing clamp of claim 1, wherein the other side of the clamp body is buckled with the clamp cover, wherein the clamp cover is provided with a slot, and the clamp body is provided with a snap body which can be buckled to the slot.

16. The multi-functional optical fiber fixing clamp of claim 3, wherein an edge of the first fiber loading slot is provided with a scale.

17. The multi-functional optical fiber fixing clamp of claim 12, wherein the clamp body includes a third position-limiting block and a fourth position limiting block, and wherein the third position-limiting block and the fourth position limiting block are positioned adjacent to the edges of the first fiber loading slot to prevent deflection of a cable.

18. The multi-functional optical fiber fixing clamp of claim 14, wherein the magnetic body provides a magnetic field strength between 3000 Gs and 4500 Gs.
